(19) United States
(12) Patent Application Publication
(10) Pub. No.: US 2014/0331500 A1
(43) Pub. Date: Nov. 13, 2014

(54) RAZOR HEAD AND RAZOR WITH THE SAME

(71) Applicant: Xiangrong Ren, Wenzhou (CN)

(72) Inventor: Xiangrong Ren, Wenzhou (CN)

(21) Appl. No.: 14/362,802

(22) PCT Filed: Nov. 16, 2012
(86) PCT No.: PCT/CN2012/084716

§ 371 Date: Jun. 4, 2014

(51) Int. Cl. B26B 21/34; B26B 21/22; B26B 21/44; B26B 21/40

(52) U.S. Cl. CPC B26B 21/34; B26B 21/4012; B26B 21/222; B26B 21/443
USPC 30/41; 30/48

(57) ABSTRACT

A razor head includes a framework, at least one razor blade, and a guide roller, the framework comprising two side parts, a front part and a rear part connecting between the two side parts respectively. The razor blade is installed between the two side parts, the guide roller is shaped as a columnar structure which is rotatably installed on the front part along a direction from one of the side parts to the other, and located at the front of a cutting edge of the razor blade, and a rotating center line of the guide roller and the cutting edge of the razor blades jointly form a first plane on which a generatrix of the guide roller is located, and the generatrix of the guide roller and the cutting edge of the razor blade are arranged in unparallel. The razor head improves shaving effect and extending normal service life.

### FIELD OF THE INVENTION

The present invention relates to a razor apparatus and, more particularly to a razor head and a razor with the same.

### BACKGROUND OF THE INVENTION

With improvement of the economy and the society, abounding consumables are offered to people to satisfy people's demand, thereby improving people's standard or living. While razors are one of these consumables.

Currently, the razors have two types including electric razors and manual razors. Regarding the manual razors, a normal usage time of the razor is depended on the razor blades thereof. User needs replace with a new razor blade if the old razor blade is damaged or dull, in order to ensure the normal usage. Therefore, the razor blade and a suitable installation thereof play an important role in maintaining the shaving effect and service life of the manual razors.

Commonly, the razor blades of the conventional manual razor do a draw-cut actuation on the beards, so as to actualize the action of shaving. However, cutting edge of the razor blades may appear some indentations in different positions due to it was rigidly impacted by the beards, which will affect the shaving effect of the manual razor on one hand, and reduce the normal service life on the other hand, thereby increasing the cost accordingly.

Thus, there is a need for a razor head and a razor with improved shaving effect and extended service life to overcome the above-mentioned drawbacks.

### SUMMARY OF THE INVENTION

One objective of the present invention is to provide a razor head thereby improving shaving effect and extending normal service life.

Another objective of the present invention is to provide a razor thereby improving shaving effect and extending normal service life.

To achieve the above-mentioned objectives, a razor head includes a framework, at least one razor blade, and a guide roller, the framework comprising two side parts, a front part and a rear part connecting between the two side parts respectively. The razor blade is installed between the two side parts, the guide roller is shaped as a columnar structure which is rotatably installed on the front part along a direction from one of the side parts to the other, and located at the front of a cutting edge of the razor blade, and a rotating center line of the guide roller and the cutting edge of the razor blades jointly form a first plane on which a generatrix of the guide roller is located, and the generatrix of the guide roller and the cutting edge of the razor blade are arranged in unparallel.

Preferably, a plane cutting area is formed by the generatrix of the guide roller and the cutting edge of the razor blade in the first plane, which is ascending or descending from one of the side parts to the other.

Preferably, the guide roller is a cylinder or a prism, and a rotating center line of the cylinder or the prism and the cutting edge of the razor blade are arranged in unparallel.

Preferably, an angle between the rotating center line of the cylinder or the prism and the cutting edge of the razor blade is smaller than or equal to 10 degrees.

Preferably, the guide roller is a truncated cone or a prismoid, and a rotating center line of the truncated cone or the prismoid and the cutting edge of the razor blade are arranged in parallel.

Preferably, a taper angle of the truncated cone or the prismoid is smaller than or equal to 10 degrees.

Preferably, the number of the razor blade is multiple, and multiple razor blades are arranged in parallel.

Preferably, the razor head further includes an accessorial lubricating strip which is installed on the rear part along a direction from one of the side parts to the other.

A razor includes a handle, a linkage connected to the handle, and a razor head mentioned above, and the framework is connected to the linkage.

Preferably, the linkage is pivoted between the two side parts.

In comparison with the prior art, since the rotating center line of the guide roller and the cutting edge of the razor blade jointly form the first plane on which the generatrix of the guide roller is located, and the generatrix of the guide roller and the cutting edge of the razor blade are arranged in unparallel, so that the generatrix of the guide roller and the cutting edge of the razor blades are aslant arranged in the first plane. As a result, when user draws the razor blade to perform a linear shaving action, the guide roller will roll and rotate about a pivot thereof at the same time, thereby continuously changing the cutting direction of the razor blades. That is, besides a draw-cut action, the shaving action of the razor blade further includes a cutting action, so that both the draw-cut action and the cutting action are concurrent. By this token, the shaving action still could be performed by the cutting action mentioned above, even if the cutting edge of the razor blades appears some indentations, by which the shaving effect of the razor head of the present invention is improved, and the normal service life is extended to reduce its usage cost. Accordingly, the razor with the razor head of the present invention also has improved shaving effect and extended service life to reduce cost.

### BRIEF DESCRIPTION OF THE DRAWINGS

The accompanying drawings facilitate an understanding of the various embodiments of this invention. In such drawings:

FIG. 1 is a perspective view of a razor with a razor head installed thereon according to a first embodiment of the present invention;

FIG. 2 is a plan view of the razor head according to the first embodiment of the present invention;

FIG. 3 is a plan view of the razor head without the assistant lubricating strip and the framework according to the first embodiment of the present invention;

FIG. 4 is a cross-sectional view along the line A-A in FIG. 2;

FIG. 5 is a schematic view of the razor head according to a second embodiment of the present invention;

FIG. 6 is a plan view of the razor head without the assistant lubricating strip and the framework according to the second embodiment of the present invention;

FIG. 7 is a cross-sectional view along the line B-B in FIG. 5;

FIG. 8 is another arrangement of the razor blades and the guide roller of the razor head shown in FIG. 5; and

FIG. 9 is a graph of relationship between an angle between the generatrix of the guide roller and the cutting edges of the razor blades, and a force applied to the razor blades.

### DETAILED DESCRIPTION OF ILLUSTRATED EMBODIMENTS

A distinct and full description of the technical solution of the present invention will follow by combining with the accompanying drawings. By all appearances, the embodiments to be described just are a part of embodiments of the present invention, not the all. Based on the embodiment of the present invention, all other embodiments obtained by the person ordinarily skilled in the art without any creative work pertain to the protection scope of the present invention.

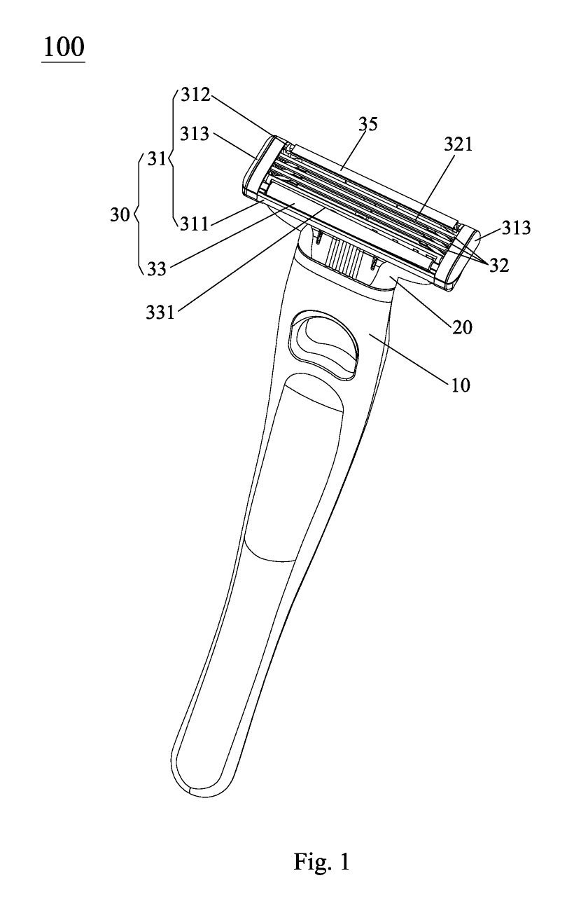

Referring to FIG. 1, it shows a razor 100 with a razor head according to a first embodiment of the present invention. As illustrated, the razor 100 includes a handle 10, a linkage 20 and a razor head 30 connected to the handle 10. The linkage 20 is connected to a framework 31 of the razor head 30 which will be described hereinafter; preferably, the linkage 20 is pivoted between two side parts 313 mentioned below, so as to make the razor head 30 pivot about the linkage 20.

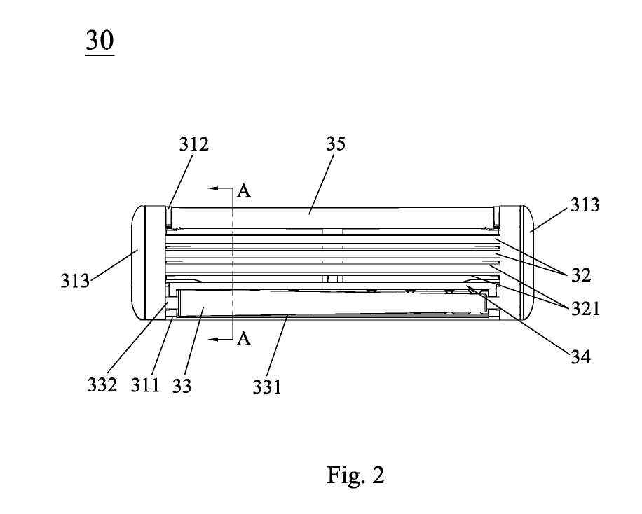

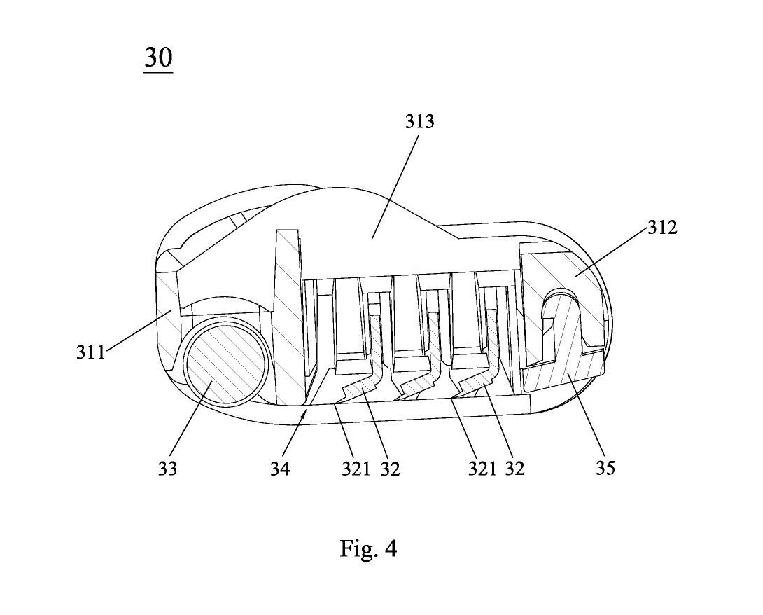

Concretely, referring to FIGS. 2-4, the razor head 30 includes a framework 31, at least one razor blade 32, and a guide roller 33. The framework 31 includes two side parts 313, a front part 311 and a rear part 312 connected between the two side parts 313, so that the two side parts 313, the front part 311 and the rear part 312 jointly form the framework 31, thereby a receiving room is provided by the framework 31 to install the razor blades 32. The razor blades 32 are installed between the two side parts 313; particularly, several razor blades 32 are arranged in parallel, so as to increase the contact area to the beard thereby improving shaving effect. Preferably, the number of the razor blades 32 is three; of course the number thereof could be one according to actual demands in other embodiments, which could realize the shaving as well.

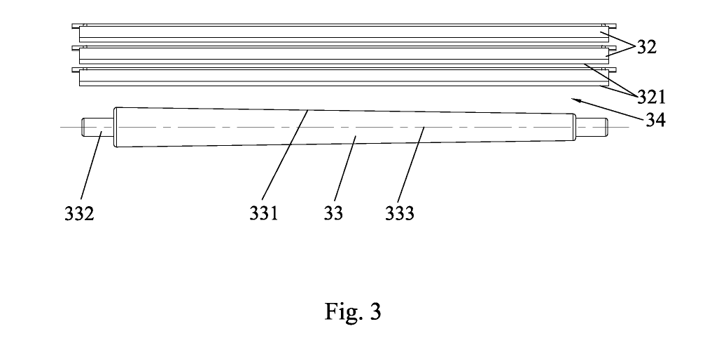

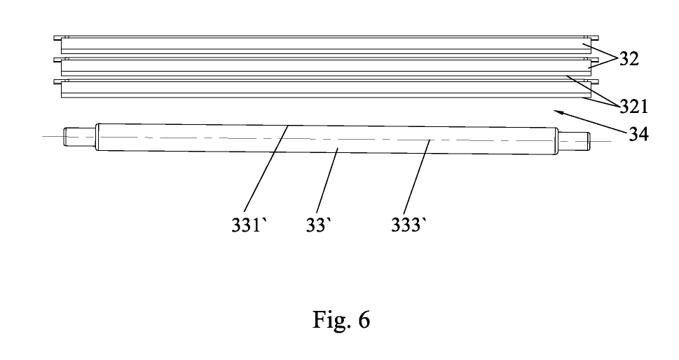

As shown, the guide roller 33 is shaped as a columnar structure, which is rotatably installed on the front part 311 along a direction from one of the side parts 313 to the other of the side parts 313 (such as a direction from left side part 313 to right side part 313 in FIG. 2). Concretely, a pivot portion 332 is extended from two sides of the guide roller 33 respectively, which is pivoted on the front part 311, so that the guide roller 33 could be installed on the front part 311 rotatably. Furthermore, the guide roller 33 is located at the front of the cutting edges 321 of the razor blades 32, and the rotating center line 333 of the guide roller 33 and the cutting edges 321 of the razor blades 32 jointly form a first plane (not labeled) on which the generatrix 331 of the guide roller 33 is located. Concretely, the generatrix 331 of the guide roller 33 and the cutting edges 321 of the razor blades 32 are not in parallel, as shown in FIG. 3 or FIG. 6. Specifically, in the present embodiment, the generatrix 331 of the guide roller 33 and the cutting edges 321 of the razor blades 32 form a plane cutting area 34 in the first plane, and the plane cutting area 34 is ascending or descending from one side part 313 to the other side part 313. For example, as shown in FIG. 3, the plane cutting area 34 is ascending from the left side part 313 to the right side part 313. Of course, it also can be descending from the left side part 313 to the right side part 313 in other embodiments, which is not described in detail. For facilitating the shaving action of the razor head 30, the razor head 30 further includes an accessorial lubricating strip 35 which is installed on the rear part 312 along a direction from one of the side parts 313 to the other of the side parts 313.

Concretely, in the instant embodiment, the guide roller 33 is a truncated cone whose rotating center line 333 and the cutting edges 321 of the razor blades 32 are arranged in parallel, so that the unparallel arrangement between the generatrix 331 of the guide roller 33 and the cutting edges 321 of the razor blades 32 is much simpler and reliable. Concretely, the taper angle of the truncated cone is smaller than or equal to 10 degrees, so as to ensure the preferable shaving effect of the razor head 30. As a result, user may apply less force to the razor head 30, thus the shaving becomes much easier. Preferably, the taper angle may select from one of 1, 2, 3, 4, 5, 6, 7, 8, 9, or 10 degrees. Further, the pivoting portion 332 is shaped as a cylinder and has a same axis with the truncated cone, in order to improve the shaving effect of the razor head 30 and extend its normal service life, finally ensure the reliability of rolling action of the guide roller 33.

Optionally, in other embodiments, the guide roller 33 can be a prismoid, preferably a right prismoid, such as triangular prismoid, pentagonal prismoid, hexagonal prismoid, heptagonal prismoid, or octagonal prismoid, etc., so that the rolling of the guide roller 33 is much easier, to offer a reliable guide. Under this situation, the rotating center line of the prismoid and the cutting edges 321 of the razor blades 32 are arranged in parallel, so that the unparallel arrangement between the generatrix 331 of the guide roller 33 and the cutting edges 321 of the razor blades 32 is much simpler and reliable. Concretely, the taper angle of the prismoid is smaller than or equal to 10 degrees, so as to ensure the preferable shaving effect of the razor head 30. As a result, user may apply less force to the razor head 30, thus the shaving becomes much easier. Preferably, the taper angle may select from one of 1, 2, 3, 4, 5, 6, 7, 8, 9, or 10 degrees, in order to improve the shaving effect of the razor head 30 and extend its normal service life.

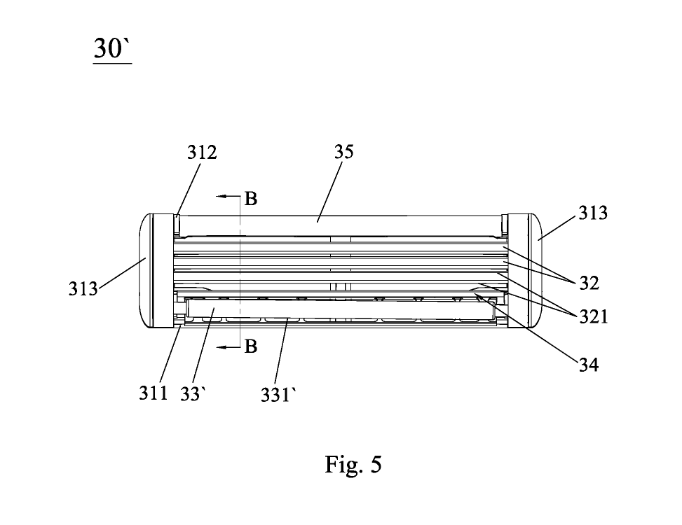

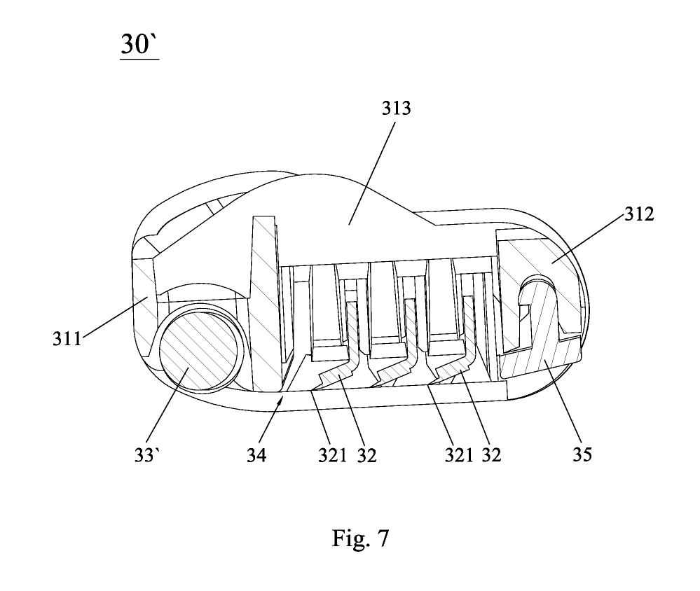

Now turn to FIGS. 5-7, and a razor head 30′ according to a second embodiment is shown, which has a similar structure with that in the first embodiment, and the differences are the arrangement of the guide roller 31 in the framework 31 and the shapes of the guide roller 31. Concretely, in the instant embodiment, the guide roller 33′ is a cylinder whose rotating center line 333′ and the cutting edges 321 of the razor blades 32 are arranged in unparallel, so that the unparallel arrangement between the generatrix 331′ of the guide roller 33′ and the cutting edges 321 of the razor blades 32 is much simpler and reliable. More specifically, an angle between the rotating center line 333′ of the cylinder and the cutting edges 321 of the razor blades 32 in the first plane is smaller than or equal to 10 degrees, so as to ensure the preferable shaving effect of the razor head 30′. As a result, user may apply less force to the razor head 30, thus the shaving becomes much easier. Preferably, the angle may select from one of 1, 2, 3, 4, 5, 6, 7, 8, 9, or 10 degrees, in order to improve the shaving effect of the razor head 30 and extend its normal service life. Optionally, in other embodiments, the guide roller 33′ can be a prism, preferably a right prism, such as triangular prism, pentagonal prism, hexagonal prism, heptagonal prism, or octagonal prism, etc., so that the rolling of the guide roller 33 is much easier to offer a reliable guide. Under this situation, the rotating center line of the guide roller 33′ and the cutting edges 321 of the razor blades 32 are arranged in unparallel, so that the unparallel arrangement between the generatrix 331 of the guide roller 33′ and the cutting edges 321 of the razor blades 32 is much simpler and reliable. Concretely, the angle of the prism is smaller than or equal to 10 degrees, so as to ensure the preferable shaving effect of the razor head 30. As a result, user may apply less force to the razor head 30, thus the shaving becomes much easier. Preferably, the taper angle may select from one of 1, 2, 3, 4, 5, 6, 7, 8, 9, or 10 degrees, in order to improve the shaving effect of the razor head 30 and extend its normal service life.

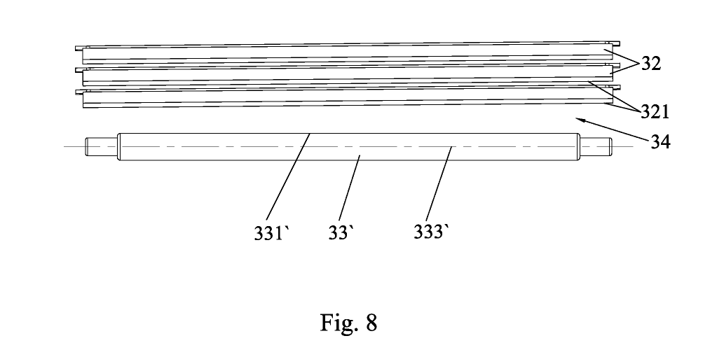

Referring to FIG. 8, it shows the arrangement between the guide roller and the razor blades of the razor head. As illustrated, the cutting edges 321 of the blades 32 is installed between the two side parts 313 and inclined to the guide roller 33′, while the guide roller 33′ is installed between the two side parts 313 and perpendicular to the side parts 313. In FIG. 6, the cutting edges 321 of the razor blades 32 are horizontally installed between the two side parts 313, and the guide roller 33′ is installed between the two side parts 313 and inclined to the cutting edges 321 of the razor blades 32 in the first plane, so that the generatrix 331′ of the guide roller 33′ and the cutting edges 321 of the razor blades 32 could be arranged in unparallel.

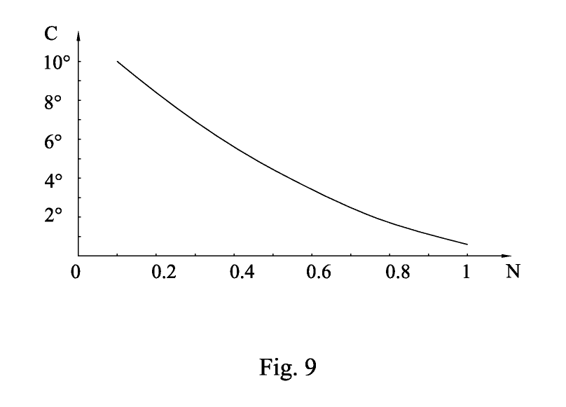

Referring to FIG. 9, it shows a graph of relationship between an angle between the generatrix of the guide roller and the cutting edges of the razor blades, and a force applied to the razor blades. As illustrated, the abscissa represents magnitude of the force, in unit of Newton; and the ordinate represents magnitude of the angle, in unit of Degree. Concretely, as shown in FIG. 9, when the angle between the generatrix 331 or 331′ of the guide roller 33 or 33′ and the cutting edges 321 of the razor blades 32 is larger, the force applied to the razor blades 32 become smaller, and such a change is linear. Preferably, the angle between the generatrix 331 or 331′ of the guide roller 33 or 33′ and the cutting edges 321 of the razor blades 32 is within 10 degrees.

In comparison with the prior art, since the rotating center line 333 or 333′ of the guide roller 33 or 33′ and the cutting edges 321 of the razor blades 32 jointly form the first plane on which the generatrix 331 or 331′ of the guide roller 33 or 33′ is located, and the generatrix 331 or 331′ of the guide roller 33 or 33′ and the cutting edges 321 of the razor blades 32 are arranged in unparallel, so that the generatrix 331 or 331′ of the guide roller 33 or 33′ and the cutting edges 321 of the razor blades 32 are aslant arranged in the first plane. As a result, when user draws the razor blades 32 to perform a linear shaving action, the guide roller 33 or 33′ will roll and rotate about a pivot thereof at the same time, thereby continuously changing the cutting direction of the razor blades 32. That is, besides a draw-cut action, the shaving action of the razor blades 32 further includes a cutting action, so that both the draw-cut action and the cutting action are concurrent. By this token, the shaving action still could be performed by the cutting action mentioned above, even if the cutting edges 321 of the razor blades 32 appears some indentations, by which the shaving effect of the razor head 30 or 30′ of the present invention is improved, and the normal service life is extended to reduce its usage cost. Accordingly, the razor 100 with the razor head 30 or 30′ of the present invention also has improved shaving effect and extended service life to reduce cost.

It should be noted that, for a cylinder or a truncated cone, the generatrix of the guide roller is the intersecting line where a plane of the axis of the column or the truncated cone intersects at a side surface of the cylinder or the truncated cone; for a prism or a prismoid, the generatrix of the guide roller is a side cutting edge of the prism or the prismoid connected between the top and the bottom.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A razor head, comprising a framework, at least one razor blade, and a guide roller, the framework comprising two side parts, a front part and a rear part connecting between the two side parts respectively; the razor blade installed between the two side parts; the guide roller shaped as a columnar structure which is rotatably installed on the front part along a direction from one of the side parts to the other, and located at the front of a cutting edge of the razor blade, wherein a rotating center line of the guide roller and the cutting edge of the razor blades jointly form a first plane on which a generatrix of the guide roller is located, and the generatrix of the guide roller and the cutting edge of the razor blade are arranged in unparallel.

2. The razor head according to claim 1, wherein a plane cutting area is formed by the generatrix of the guide roller and the cutting edge of the razor blade in the first plane, which is ascending or descending from one of the side parts to the other.

3. The razor head according to claim 2, wherein the guide roller is a cylinder or a prism, and a rotating center line of the cylinder or the prism and the cutting edge of the razor blade are arranged in unparallel.

4. The razor head according to claim 3, wherein an angle between the rotating center line of the cylinder or the prism and the cutting edge of the razor blade is smaller than or equal to 10 degrees.

5. The razor head according to claim 2, wherein the guide roller is a truncated cone or a prismoid, and a rotating center line of the truncated cone or the prismoid and the cutting edge of the razor blade are arranged in parallel.

6. The razor head according to claim 5, wherein a taper angle of the truncated cone or the prismoid is smaller than or equal to 10 degrees.

7. The razor head according to claim 1, wherein the number of the razor blade is multiple, and multiple razor blades are arranged in parallel.

8. The razor head according to claim 1, further comprising an accessorial lubricating strip which is installed on the rear part along a direction from one of the side parts to the other.

9. A razor, comprising a handle, a linkage connected to the handle, and a razor head according to claim 1, wherein the framework is connected to the linkage.

10. The razor according to claim 9, wherein the linkage is pivoted between the two side parts.

11. The razor according to claim 9, wherein a plane cutting area is formed by the generatrix of the guide roller and the cutting edge of the razor blade in the first plane, which is ascending or descending from one of the side parts to the other.

12. The razor according to claim 11, wherein the guide roller is a cylinder or a prism, and a rotating center line of the cylinder or the prism and the cutting edge of the razor blade are arranged in unparallel.

13. The razor according to claim 12, wherein an angle between the rotating center line of the cylinder or the prism and the cutting edge of the razor blade is smaller than or equal to 10 degrees.

14. The razor according to claim 11, wherein the guide roller is a truncated cone or a prismoid, and a rotating center line of the truncated cone or the prismoid and the cutting edge of the razor blade are arranged in parallel.

15. The razor according to claim 14, wherein a taper angle of the truncated cone or the prismoid is smaller than or equal to 10 degrees.

16. The razor according to claim 9, wherein the number of the razor blade is multiple, and multiple razor blades are arranged in parallel.

17. The razor according to claim 9, further comprising an accessorial lubricating strip which is installed on the rear part along a direction from one of the side parts to the other.
